(19) United States
(12) Patent Application Publication
(10) Pub. No.: US 2023/0390951 A1
(43) Pub. Date: Dec. 7, 2023

(54) FOLDING KNIFE THAT CAN BE DISSEMBLED WITHOUT TOOLS

(71) Applicant: Avian Knives LLC, Fall Branch, TN (US)

(72) Inventor: Seth Taylor, Johnson City, TN (US)

(21) Appl. No.: 17/831,194

(22) Filed: Jun. 2, 2022

(51) Int. Cl. B26B 1/04; B26B 1/10

(52) U.S. Cl. CPC B26B 1/046; B26B 1/10

(57) ABSTRACT

The present disclosure provides a folding knife. The knife according to the present disclosure includes several components. Under a preferred disassembly operation, the knife can be disassembled into the following parts: a connection pin, a first frame member of a handle of the knife, a second frame member of a handle of the knife, a latch at the end of the handle, a back frame member between the first and second frame members of the handle, a pivot retainer on the second frame member, and a blade of the knife.

### BACKGROUND

### Technical Field

The present disclosure relates to folding knives, and more specifically, to a folding knife that can be taken apart without using any tools.

### Background

Many of the knives in the market have the capability of being taken apart and put back together by the customer to permit cleaning, maintenance, repair or the replacement of parts. Some of the knives require tools to be disassembled while others are capable of being taken apart and put back together without using tools.

### BRIEF SUMMARY

A knife according to the present disclosure is capable of being fully disassembled by following a specific sequence without using any types of tools. The knife can be assembled using the opposite sequence of disassembling the knife.

The knife according to the present disclosure includes several components. Under a preferred disassembly operation, the knife can be disassembled into the following parts: 1) a first connection pin, 2) a first frame member of a handle of the knife, 3) a second frame member of a handle of the knife, 4) a latch at the end of the handle, 5) a back frame member between the first and second frame members of the handle, 6) a pivot retainer on the second frame member, 7) a second connection pin, and 8) a blade of the knife.

Under the preferred disassembly operation, a latch at a first end of a handle is released from a closed position (e.g., locked position) to an open position (e.g., unlocked position). The rotation of the latch causes the first connection pin coupled to the latch to rotate. When the first connection pin is fully rotated by the latch a first end of the first connection pin is aligned with a hole in the first frame member to permit the first connection pin to be slidably removed from the first and second frame members, the back frame member, and the latch. When the first connection pin is fully removed, the back frame member can rotate about a pin at a second end of the knife. When the back frame member is lifted up, the pivot retainer that is held in the locked down position on the back frame member can be released from its position on the second frame member. The release of the pivot retainer allows a user to separate the first and second frame members, the back frame member, and the blade from each other. In sum, the knife according to the present disclosure may be taken apart according to the preferred disassembly operation described above only using the user's hands; no tools are needed.

The assembly operation can be performed by employing the opposite sequence of the sequence for the disassembly operation. That is, after the first and second frame members, the blade, and the back frame member are aligned, the second connection pin slides through the corresponding hole in each of them. The pivot retainer is slidably inserted on the second frame member to couple to and lock in position a head of the second connection pin extending through the first frame member, the blade, and the second frame member. The pivot retainer couples to the head of the pin protruding from a side surface of the second frame member. Once the pivot retainer is fully inserted, the back frame member which is coupled to both sides of the first and second frame members rotates along the axis of the pin at the second end of the knife and a bottom surface of the back frame member contacts and pushes down the top surface of the pivot retainer (or the back frame member holds in the pivot retainer) to place the pivot retainer in a closed position (e.g., locked position). When the back frame member is fully rotated down to a closed position (e.g., locked position), the first connection pin is inserted into holes that extend through each of the first frame member, the latch, the back frame member, and the second frame member. Finally, the latch is rotated from an open position to a closed position which concurrently causes the connection pin to rotate so that the first frame member, the latch, the back frame member, and the second frame member are held together in a locked position by the connection pin.

The knife according to the present disclosure does not include tool required fastening means such as bolts or nuts. The knife is fastened and held together using a combination of the connection pins, pivots, detents and other components, including a latch, that are positioned to ensure that the knife is securely held together when the latch is in the closed position and can be easily taken apart when the latch is rotated by hand to the open position.

### BRIEF DESCRIPTION OF THE SEVERAL VIEWS OF THE DRAWINGS

FIG. 1 is an isometric view of a display side of a folding knife according to one embodiment of the present disclosure.

FIG. 2A is a side view of a display side of the folding knife of FIG. 1 in an open state.

FIG. 2B is a side view of a display side of the folding knife of FIG. 1 in a folded state.

FIG. 3 is an exploded view of the various components included in the folding knife of FIG. 1 according to one embodiment of the present disclosure.

FIG. 4A is an isometric view of a back side of the folding knife of FIG. 1.

FIG. 4B is a close up view of an end of the folding knife of FIG. 1 from a display side in a closed position.

FIG. 4C is a close up view of an end of the folding knife of FIG. 1 from a display side in an open position.

FIG. 4D is an exploded view including a first frame member, a latch, and a first connection pin to describe how the latch rotates the first connection pin from a closed position to an open position.

FIG. 4E is an enlarged view of the first connection pin according to one embodiment of the present disclosure.

FIG. 4F shows the latch and the first connection pin in a closed position.

FIG. 4G shows the latch and the first connection pin in a fully open position or a fully unlocked position.

FIG. 4H shows the latch and the first connection pin halfway opened.

FIG. 4I show a hole in the first frame member;

FIG. 4J shows how a first oval portion of the first connection pin and a first cylindrical portion rotates within a first portion and a second portion of a hole, respectively.

FIG. 5 illustrates a view of removing the first connection pin from the hole when the latch is in a completely opened position.

FIG. 6A illustrates releasing a back frame member by lifting up or rotating along an R-axis.

FIG. 6B illustrates a close up view of the back frame member lifted up to permit removal of a first pivot retainer for disassembling the folding knife of FIG. 1.

FIG. 7 shows the knife with the latch, a pocket clip, and the connection pin removed from the folding knife of FIG. 1.

FIG. 8 shows the first pivot retainer slidably removed from the knife along an S-axis.

FIG. 9 shows a second connection pin removed and a second pivot retainer detached from the first frame member.

FIG. 10A shows a pin separated from the back frame member.

FIG. 10B shows a top view of the pin and the back frame member.

FIGS. 11 and 12 show exploded views of the knife of FIG. 1 being further disassembled.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures, configurations associated with knives, folding knives, and other various structures associated with the above have not been shown or described in detail to avoid unnecessarily obscuring descriptions of the embodiments.

Unless the context indicates otherwise, throughout the specification and claims which follow, the word “comprise” and variations thereof, such as, “comprises” and “comprising” are to be construed in an open, inclusive sense that is as “including, but not limited to.” The terms such as “including,” “having” used herein are generally intended to allow other components to be added unless the terms are used with the term “only”. Further, the terms “first,” “second,” and similar indicators of the sequence are to be construed as interchangeable unless the context clearly dictates otherwise.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto. Like reference numerals generally denote like elements throughout the specification.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

A size and a thickness of each component illustrated in the drawing are illustrated for convenience of description, and the present disclosure is not limited to the size and the thickness of the component illustrated. However, the specific shapes, sizes, dimensions (e.g., length, width, height, thickness, radius, diameter, area, etc.), ratios, angles, number of elements of the example knife illustrated in the drawings are of an actual embodiment according to the present disclosure.

The features of various embodiments of the present disclosure can be partially or entirely adhered to or combined with each other and can be interlocked and operated in technically various ways, and the embodiments can be carried out independently of or in association with each other.

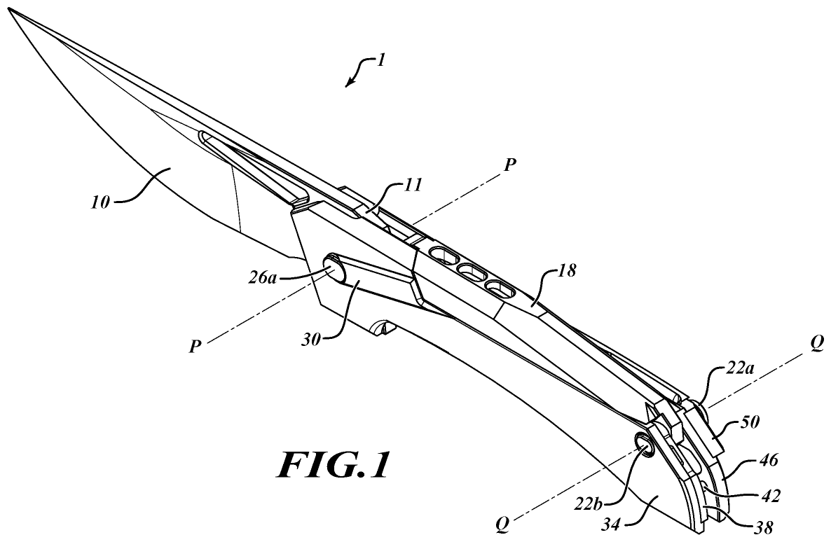

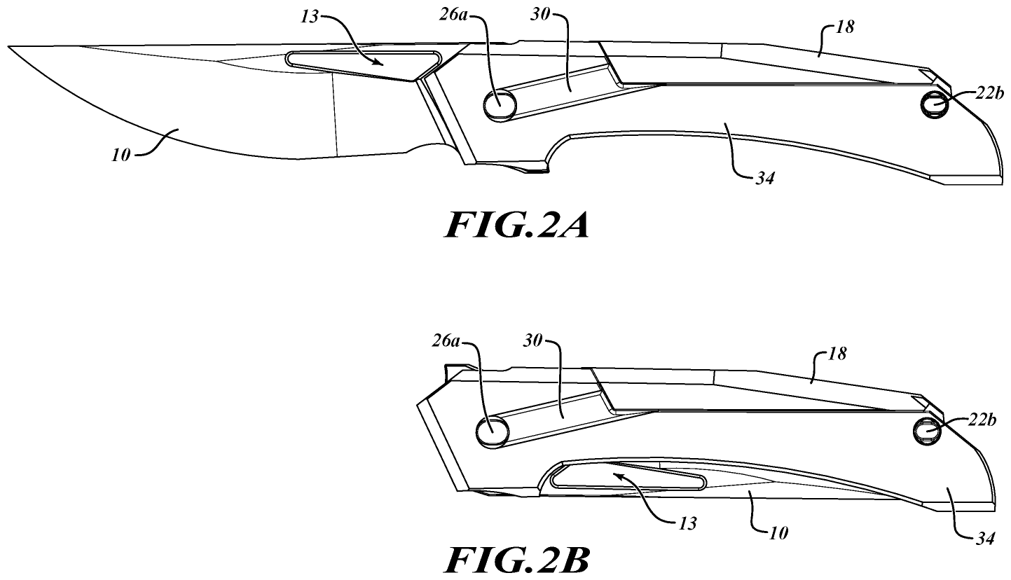

FIG. 1 is an isometric view of a display side of a folding knife 1 according to one embodiment of the present disclosure. The display side of the folding knife 1 is the side where a first frame member 34 is shown. FIG. 2A is a side view of a folding knife in an open position according to one embodiment of the present disclosure. FIG. 2B is a side view of a folding knife in a closed position according to one embodiment of the present disclosure.

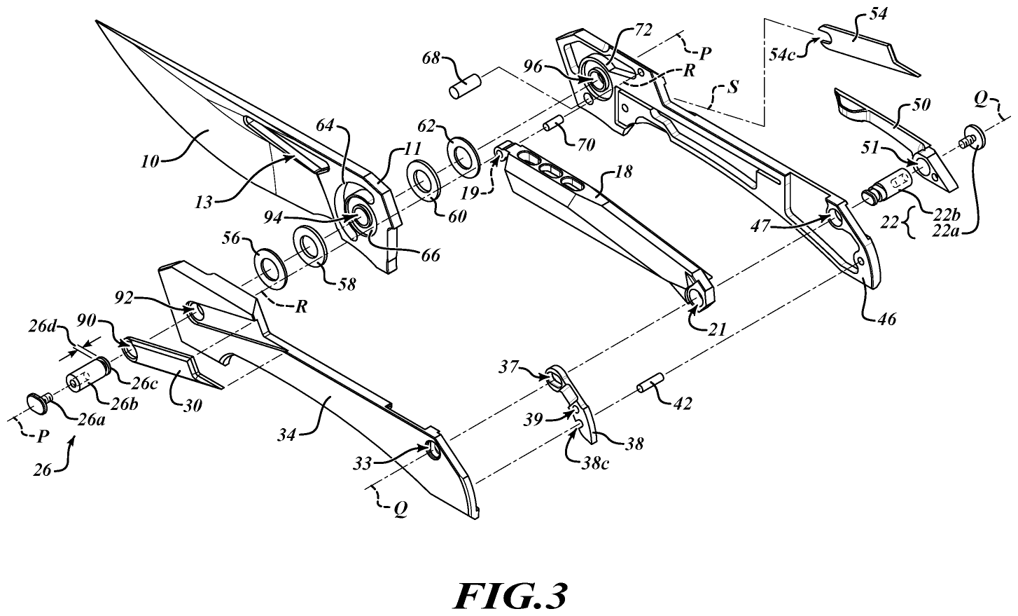

Referring to FIG. 1, the folding knife has a blade 10 with a tang 11 pivotally connected to a first pin 26 or a first connection pin 26 (FIG. 1 only shows a head of the first pin 26a of a first frame member 34 and an opposite second frame member 46 so that the blade 10 pivots with respect to the both frames 34, 46 (also collectively referred to as “a handle of the knife”) about a pivot axis P between an open position (see FIG. 2A) and a closed position (see FIG. 2B). The first pin 26 includes a head 26a and a body 26b (see FIG. 3). The first pin 26 extends to the other side of the frame (i.e., second frame member 46) which is not shown from the view in FIG. 1.

FIG. 1 further shows a second pin 22 (or a second connection pin 22) including a head 22a and a body 22b. The view visible from FIG. 1 shows an oval end of the body 22b of the second pin 22. A latch 38 is adjacent to the first frame member 34 and is connected through the second pin 22. The latch 38 is capable of rotating along an axis Q. In FIG. 1, the latch 38 is in a closed position and rests on a holding pin 42. When a user of the knife 1 wishes to take the knife apart for cleaning purposes or other purposes, the first step for the user is to move the latch 38 into an open position by releasing the latch 38 from the holding pin 42 and rotating it along the Q-axis in an opposite direction of where the holding pin 42 is fixated. The detail order of how to take the knife apart will be explained in the subsequent drawings. The knife 1 also includes a pocket clip 50 so that the user may use the clip to put the knife into his pocket using the pocket clip 50 of the knife 1. The detail view of the pocket clip 50 is shown in various figures including FIG. 3.

Referring to FIGS. 2A and 2B, in the open position, the blade 10 is extended away from the handle so that it is deployed and ready for use. From the open position, the blade 10 can be folded toward the handle into the closed position, in which the blade is partially received for storage within a space defined in the handle (e.g., space between the first frame member 34 and the second frame member 46).

The blade 10 includes an open space (or hole) 13 for decorative reasons and it also can assist some users in being able to use their fingers to pull out the blade 10 from a closed position.

FIG. 3 is an exploded view of the various components included in a knife according to one embodiment of the present disclosure.

Components aligned along the P-axis will be explained. In the center portion of the P-axis, a blade 10 includes a C-shaped hole 64 and adjacent to it a circular recess 66 for the bearings 58, 60 and the washers 56, 62. In one embodiments, the bearings 58, 60 may be skiff bearings. A first frame member 34 and a second frame member 46 includes a recess 72 to accommodate the bearings 58, 60 and the washers 56, 62. A circular recess 72 is shown in the inner surface of the second frame member 46. A corresponding recess in the inner surface of the first frame member 34 is not shown from the view in FIG. 3. A pin 68 is connected to both the second frame member 46 and the first frame member 34. (FIG. 3 only shows the recess in the second frame member 46 that the pin 68 fits into. However, a corresponding recess is located on the corresponding location of the first frame member 34). The pin 68 allows the C-shaped the blade 10 to rotate along the C-shaped hole 64. The pin 68 will be positioned at the outermost end of the C-shaped hole 64 when the knife 1 is in a closed position and the pin 68 will be positioned at the opposite outermost end of the C-shaped hole 64 when the knife 1 is in an open position.

A first pin 26 which has a head portion 26a, a first body portion 26b, a bottom portion 26c, and a second body portion 26d between the first body portion 26b and the bottom portion 26c. As shown, the second body portion 26d has a smaller diameter than the diameter of the adjacent first body portion 26b and the bottom portion 26c. The first pin 26 can be taken apart but are generally used together as one piece.

The first pin 26 connects all the components along the P-axis together. When the knife is fully assembled and ready for use, the first pin 26 extends through a hole 90 of the first pivot member 30, a hole 92 of the first frame member 34, a hole 94 of the knife blade and a hole 96 of the second frame member 46. The pin 26 is held in position by the second pivot retainer 54 as explained elsewhere herein. On the first frame member 34, a first pivot retainer 30 is located. On the other side, a second pivot retainer 54 is located on the second frame member 46.

The term “hole” is used herein with its broadest meaning and includes aperture, space, blind hole and the like. To the extent a more specific meaning is intended, this will be clear from the text of the application, the figures, the use and the context.

The first pivot retainer 30 includes a circular shape on one end that allows the first pin 26 to extend through. The second pivot retainer 54, on the other hand, includes a C-shape on the same corresponding end that allows the first pin 26 to extend through. In a locked position or in an assembled position, the C-shaped end 54c of the second pivot retainer 54 connects to the second body portion 26d and rests on the second body portion 26d to snugly fit between the space between the first body portion 26b and the bottom portion 26c.

However, during a disassembly process of the knife 1, the second pivot retainer 54 slidably moves out from the second body portion 26d of the first pin 26 and detaches from the second frame member 46 along an S-axis. The first pivot retainer 30 is also referred to as an inactive pivot retainer and the second pivot retainer 54 is also referred to as an active pivot retainer in the sense that during the disassembly process of the knife 1, the first pivot retainer 30 is attached to the first frame member 34 through the first pin 26 and is not disassembled or taken apart according to the preferred disassembly process. That is, the preferred disassembly process is for the user to easily take the knife apart only using the user's hand and fingers. For example, although possible but not preferred, a user may be able to disassemble the knife 1 by using additional tools other than the user's hand and fingers. The second pivot retainer 54, on the other hand, is capable of slidably moving out of the second frame member 46 by releasing itself from the second body portion 26d of the first pin 26 during a preferred disassembly process. Accordingly, the second pivot retainer 54 is referred to as an active pivot retainer as it takes an active role during the preferred disassembly process.

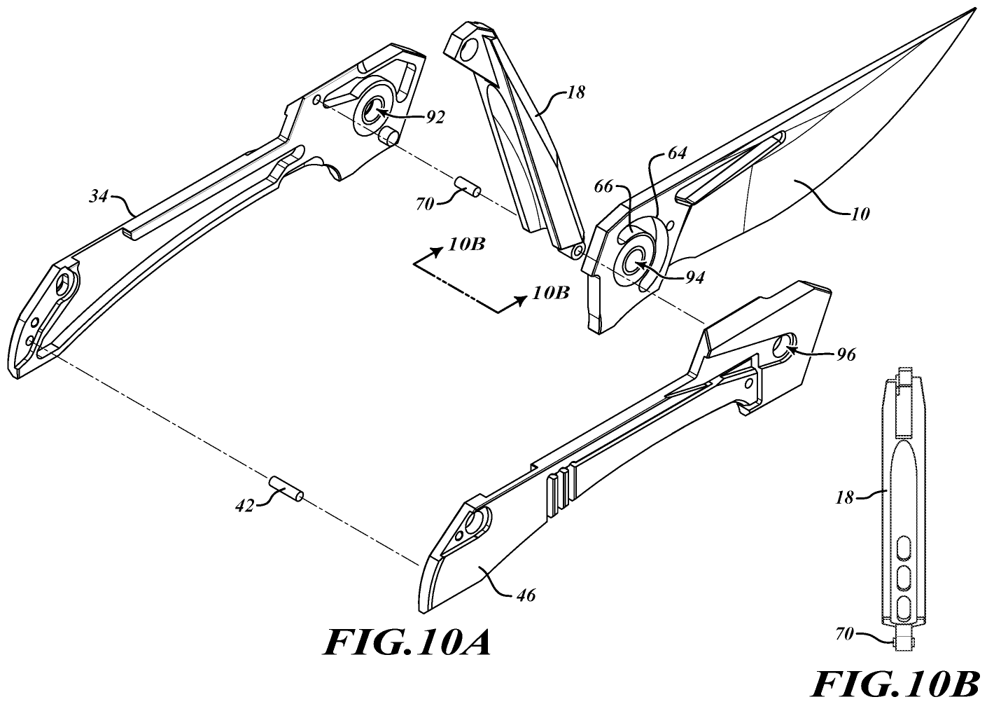

Components aligned along an R-axis will be explained. In the center portion of the R-axis, a back frame member 18 includes two circular holes 19, 21 on each distal end of the back frame member 18. A first circular hole 19 at an end of the back frame member 18 closer to the blade 10 has a smaller diameter than a second circular hole 21 at an opposite end of the back frame member 18. A third pin 70 extends through the first circular hole 19. Each end of the third pin 70 are fit in a recess at each frame 34, 46, respectively. The length of the third pin 70 in the R-axis direction is sufficiently long to protrude on both sides of the back frame member 18 but does not extend through the first frame member 34 and the second frame member 46 (see FIG. 10B).

Components aligned along a Q-axis will be explained. A second circular space 21 of the back frame member 18, an hole 37 of the latch 38, a hole 33 of the first frame member 34, a space 47 of the second frame member 46, a hole 51 of the pocket clip 50 is aligned on the Q-axis, and the second pin 22 extends through the above-mentioned holes and connects them together.

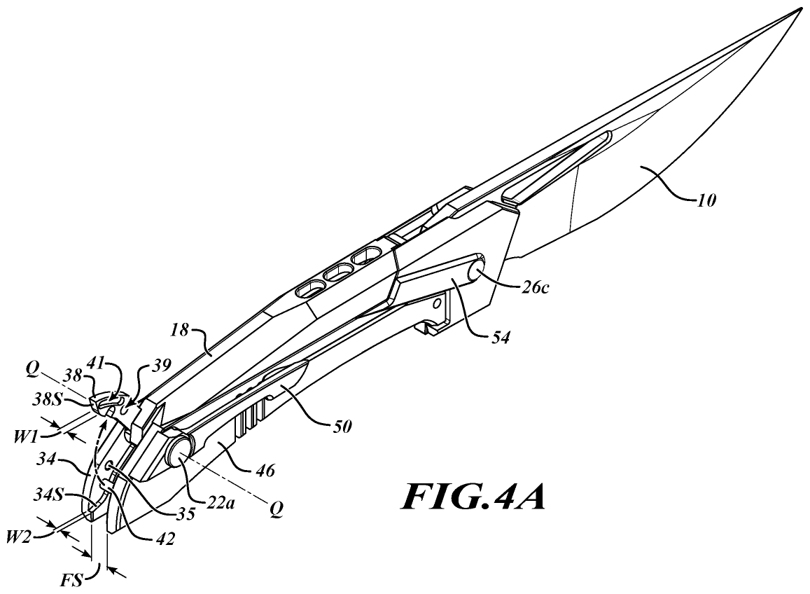

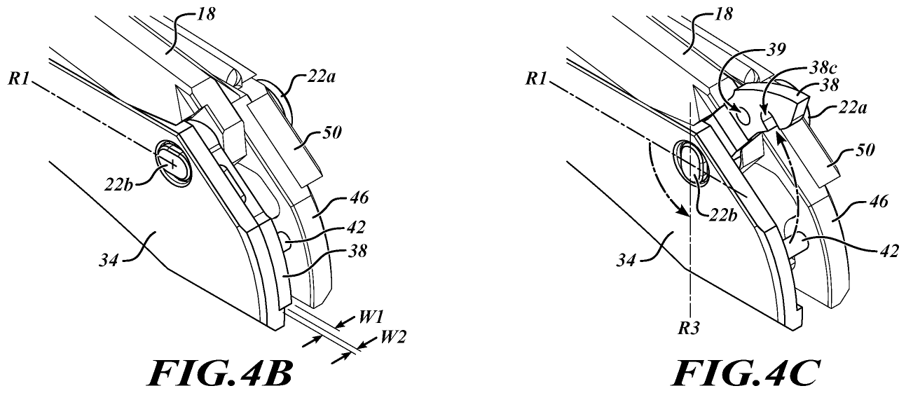

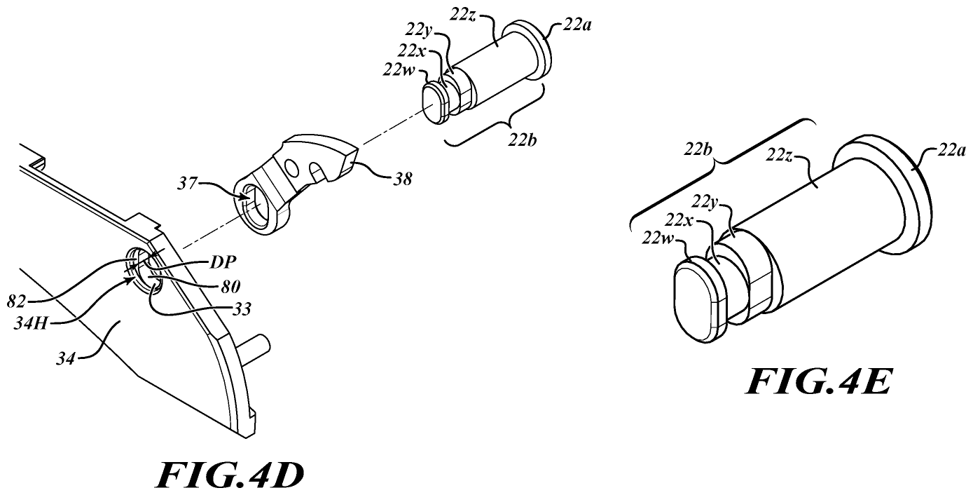

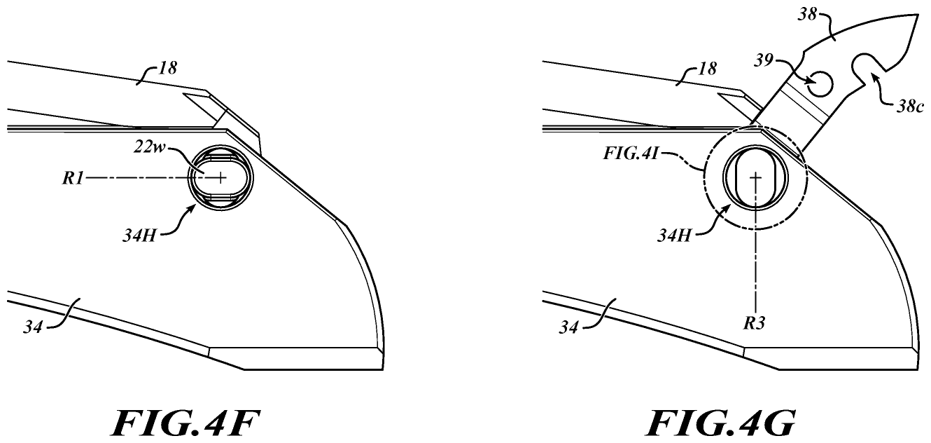

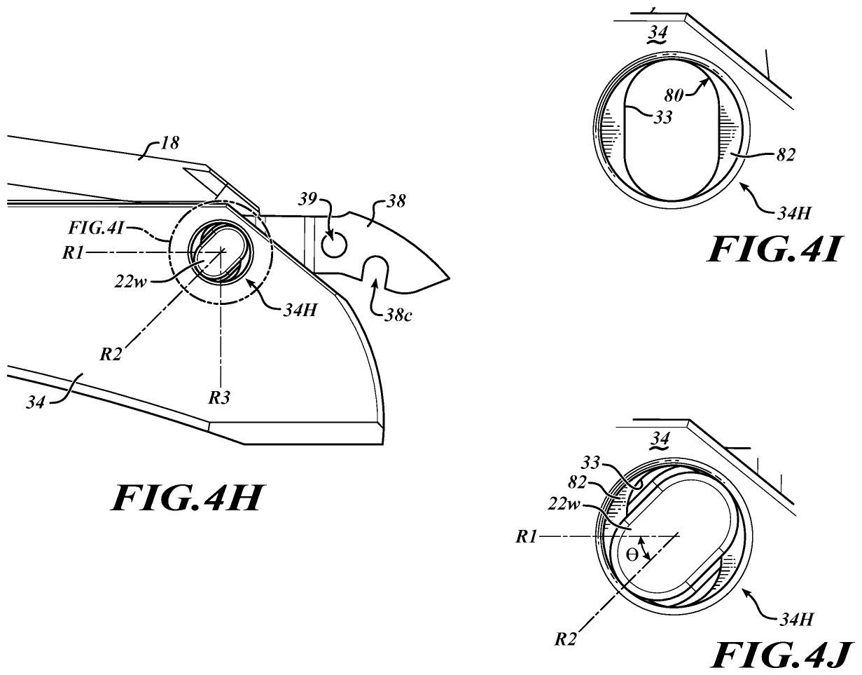

The second pin 22 includes a head portion 22a and a body portion 22b. Generally, the head portion 22a and the body portion 22b are connected to each other and used as a single piece. For example, during the disassembly process, the head portion 22a is not separated from the body portion 22b. The body portion 22b includes various sections which will be described in connection with FIG. 4E.

FIGS. 4A, 4B, 4C, 4D, 5, 6A, 6B, 7, 8, 10A illustrate a preferred sequence of disassembling a knife according to one embodiment of the present disclosure.

FIG. 4A is an isometric view of a lock side of a folding knife 1. The lock side of the folding knife 1 is the side where a second frame member 46 is shown with various locking and unlocking mechanisms.

Referring to FIG. 4A, the figure shows a latch 38 being released from a holding pin 42. The latch 38 rotates along the Q-axis as shown with the arrow.

A user may use their finger to access a space FS between the first frame member 34 and the second frame member 46 to remove the latch 38 from the holding pin 42. The latch 38 has a bottom surface 38S that sits on an inner shelf surface 34S of the first frame member 34. A width W1 of the bottom surface 38S is greater than a width W2 of the inner shelf surface 34S so as to provide a space for the user's finger to push up the latch 38 when the user wishes to disassemble the knife 1.

The latch 38 closes when it hits a shelf or the inner shelf surface 34S. The recess 38c contacts and wraps around the holding pin 42. The holding pin 42 provides additional measure to hole the latch 38 closed and to also let the user know when the latch is locked in the closed position.

The latch 38 also includes a recess 41 also referred to as a fingernail box 41, for short in some instances, a nail box 41. This permits the user to alternatively place their fingers between the space FS to place their fingernail, into the nail box 41 of the latch 38 and lift the latch 38 up to release it from a closed or locked position. That is, the fingernail box 41 assists the user to get a hold of the latch 38 so that the user can use their finger nail to open the latch 38.

The latch 38 includes a hole 39 for a detent 35 on a first frame member 34. The detent 35 also provides a firm locked position in additional to the holding pin 42 and the inner shelf surface 34S of the first frame member 34. The hole 39 can be a blind hole, namely a recess or a complete hole. The type of detent 35 shown in FIG. 4A is a ball detent. As shown, the detent 35 has a ceramic ball in it and goes into the hole or hole of the latch 38. The detent 35 will keep it sufficiently firmly in place but if the user presses hard enough, the user will be able to pop it open. However, any type of detent may be used and the present disclosure is not limited to the detent shown in FIG. 4A.

FIG. 4B is a close up view of an end of a knife from a display side in a closed position. In FIG. 4B, when the latch 38 is in a completely closed position, an oval end of the body 22b of the second pin 22 is aligned along an R1-axis.

FIG. 4C is a close up view of an end of a knife from a display side in an open position. In FIG. 4C, the latch 38 is completely opened and the oval end of the body 22b of the second pin 22 is aligned along an R3-axis. That is, the hole 37 of the latch 38 contacts the second pin 22 and rotates the second pin 22 as the latch 38 rotates. A recess 38c (e.g., a C-shaped recess 38c) of the latch 38 is released from the holding pin 42 when the latch 38 starts to rotate from the R1-axis to the R3-axis.

FIG. 4D is an exploded view including a first frame member 34, a latch 38, and a second pin 22 to describe how the latch 38 rotates the second pin 22 from a closed position to an open position. FIG. 4E is an enlarged view of a second pin 22 according to one embodiment of the present disclosure.

Referring to both FIGS. 4D and 4E, the second pin 22 includes several parts. The second pin 22 includes a head portion 22a and a body portion 22b. The body portion 22b is has four sections. A first oval portion 22w (or an oval head portion 22w), a first cylindrical portion 22x, a second oval portion 22y, and a second cylindrical portion 22z.

The second oval portion 22y has substantially the same or similar dimension and size as hole 37 of the latch 38. When the second pin 22 enters into the latch 38, the size of the second oval portion 22y snuggle fits into the hole 37 of the latch 38 so that when the latch 38 rotates, this causes the second pin 22 to also rotates accordingly. The second pin 22 enters into the hole 37 of the latch 38 until a side surface of the latch 38 contacts a leftover surface between the second oval portion 22y and the second cylindrical portion 22z.

A hole 34H in the first frame member 34 includes two portions so that the first oval portion 22w and the first cylindrical portion 22x can enter into the hole 34H. A first portion includes a recess having walls or side walls 80 that has a size and dimension so that once the first oval portion 22w enters the hole 34H, the second oval portion 22y can further rotate within the walls 80 between a closed position (e.g., position along the R1-axis) and a completely open position (e.g., position along the R3-axis). The first portion is a hole having an oval shape 33. The hole 34H has a second portion that includes a different recess. The second portion has a circular shape and includes retaining member 82 on the edges that is not aligned with the oval shape. The retaining member 82 permits the head 22w of the pin 22 to be held in the locked position in the hole 34H when it is perpendicular to the oval opening 33.

FIGS. 4F, 4G, 4H illustrate a side view of how a first oval portion 22w of a second pin 22 rotates according to the rotation of a latch 38. FIG. 4I illustrates a close up view of a hole 34H having a first oval portion recess 80 with the first connection pin 22 fully removed. FIG. 4J illustrates a close up view of a hole 34H and a first oval portion 22w of a second pin 22 when a latch 38 is about halfway between a completely opened position and a closed position. As shown, angle θ formed between R1-axis (at a closed position) and R2-axis may be any acute angle between 0° and 90°. In FIG. 4J, angle θ is about 45°.

FIG. 4F shows the latch 38 and the second pin 22 in a closed position. The closed position as used herein may also be interchangeably used with a locked position. Here, the movement (in particularly, the rotation) of the latch 38 and the second pin 22 is synchronized with each other. FIG. 4G shows the latch 38 and the second pin 22 in a fully open position or a fully unlocked position. The latch 38 enters into an open position or an open position state once the user exerts force to the latch 38 so as to release it from the holding pin 42. At this time, the detent on the first frame member 34 also releases the latch 38 from its closed position. FIG. 4H and FIG. 4J show the latch 38 and the second pin 22 halfway opened.

FIG. 4J shows how the first oval portion 22w and the first cylindrical portion 22x rotate within the first portion and second portion of the hole 34H, respectively. As shown from the close up view of the hole 34H, the oval end 22w of the pin is perpendicular to the hole (e.g., oval hole) of the other side of the knife 1 when it is inserted. The oval end 22w may rotate from R3 axis or R3 position to R2 and R1 to come to a complete closed position.

FIG. 4I shows a hole 33 in the first frame member 34. This hole 33 is oval in shape and is just slightly larger than the end 22w of the pin 22 so that the pin 22 can fit through the oval hole 33 when it is properly aligned, but cannot fit through the hole 33 when it is not exactly aligned with the oval shape of the opening. The hole 34H has a recess with walls 80 and retaining member 82 on the edges that is not aligned with the oval shape. The retaining member 82 permits the head 22w of the pin 22 to be held in the locked position in the hole 34H when it is perpendicular to the oval opening 33. The depth of the recess DP is selected to match the height of the head of the 22w so that the top most edge of the head 22w is aligned with the surface of the first frame member.

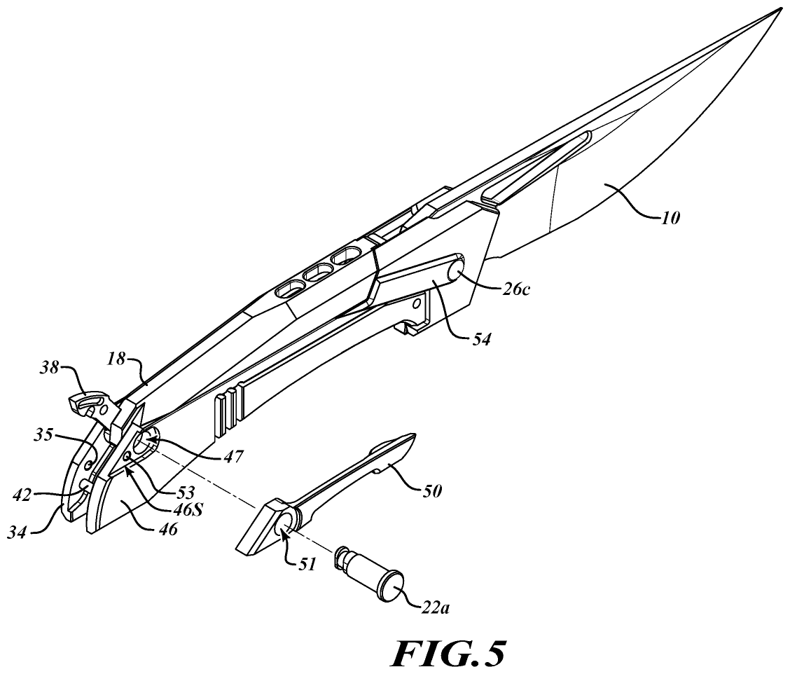

FIG. 5 illustrates a view of removing a second pin 22 from the hole 34H when a latch 38 is in a completely opened position. When the latch 38 is in a completely opened position, the second pin 22 can be easily pulled out using the user's fingers.

A second cylindrical portion 22z of the second pin 22 contacts an inner surface of a hole 51 of a pocket clip 50 and contacts an inner surface of a hole 47 of the second frame member 46. A detent 53 is located adjacent to the hole 47 of the second frame member 46 so that the pocket clip 50 can be firmly fixated in position. The detent 53 serves as additional means on top of the second pin 22 to place the pocket clip 50 to the second frame member 46. A shelf surface 46S of the second frame member 46 may also serve as a place for the pocket clip 50 to rest on and also fixate its position to the second frame member 46.

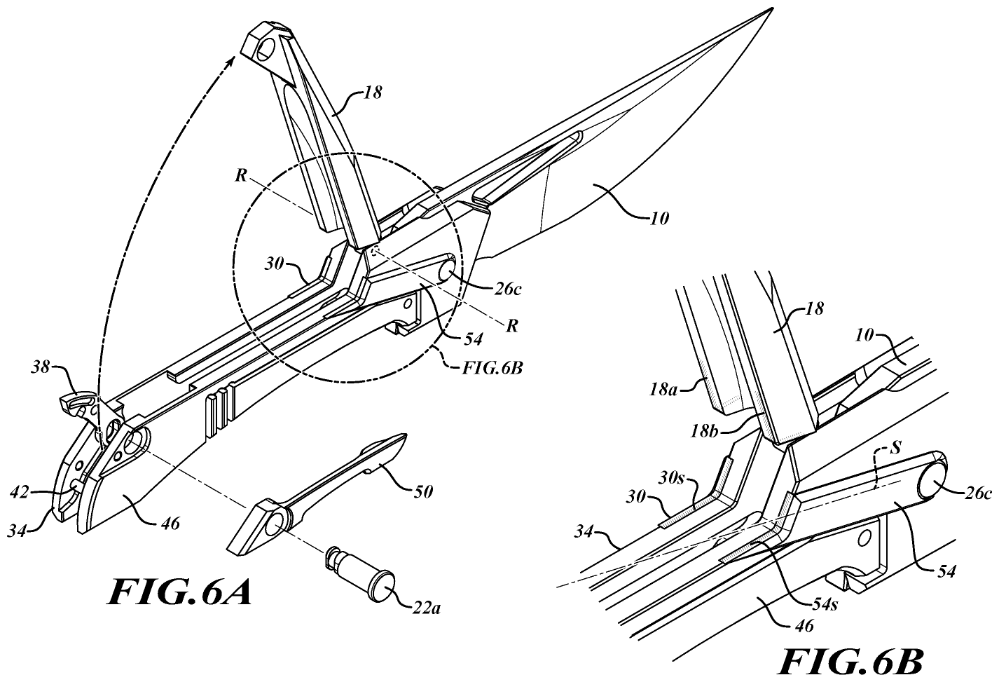

FIG. 6A illustrates releasing a back frame member 18 by lifting up or rotating along an R-axis. Here, the back frame member 18 is still connected to both the first frame member 34 and the second frame member 46 through a pin 70. The pin 70 allows the back frame member 18 to rotate along the R-axis shown in FIG. 3.

FIG. 6B illustrates a close up view of a back frame member lifted up for disassembling. Before the back frame member 18 was lifted up, bottom surfaces 18a, 18b of the back spacer were contacting a side surface 30s of a first pivot retainer 30 and a side surface 54s of a second pivot retainer 54. The bottom surface 18b of the back frame member 18 holds down the second pivot retainer 54 from slidably moving out along the S-axis. As described previously, under the preferred disassembly process according to one embodiment of the present disclosure, the first pivot retainer 30 is not removed or released contrary to the second pivot retainer 54.

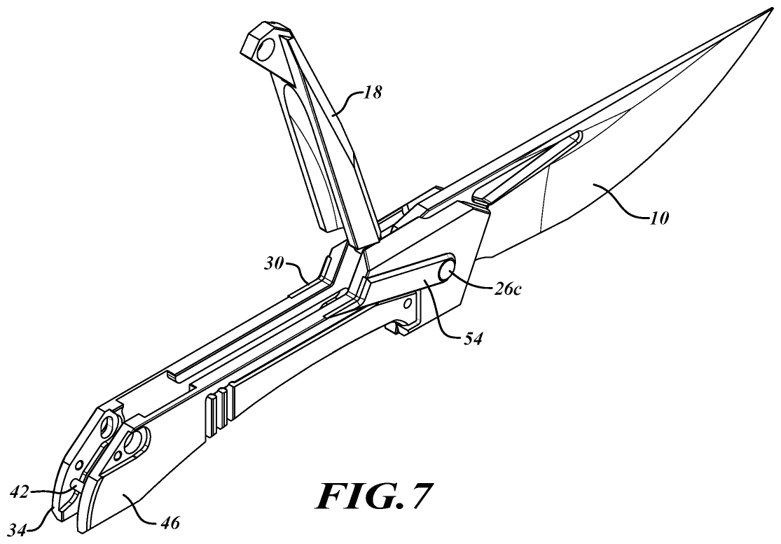

FIG. 7 shows knife 1 with the latch 38, the pocket clip 50, and the pin 22 fully removed from the knife 1.

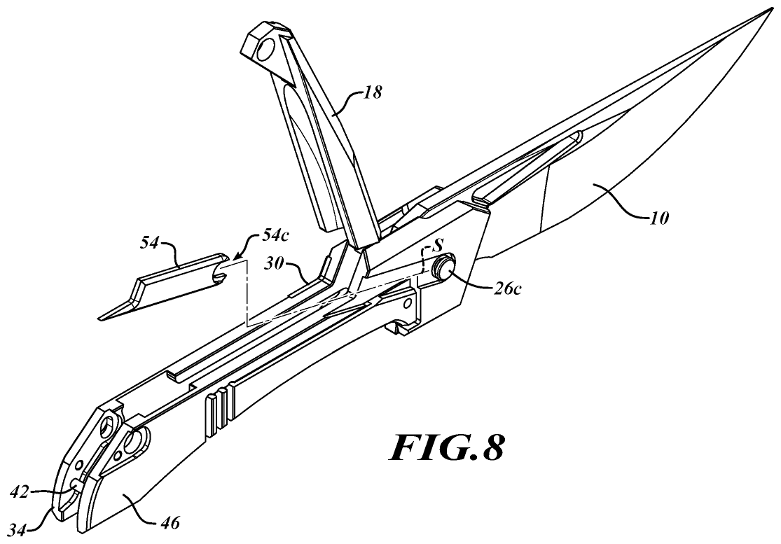

FIG. 8 shows a second pivot retainer 54 slidably released along an S-axis. A C-shaped portion 54c of a second pivot retainer 54 fits into the second body portion 26d and rests on the second body portion 26d to snugly fit in the space between the first body portion 26b and the bottom portion 26c. The C-shaped recess 54c therefore holds the pin 26 in the locked position, with the head of the pin being retained in place and not able to move until the pivot retainer is removed.

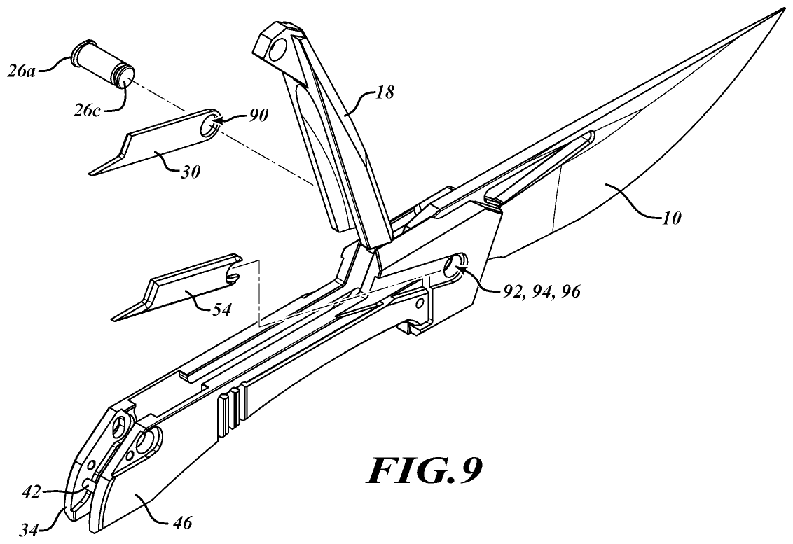

FIG. 9 shows that the first pin 26 can be taken out and also shows that the first pivot retainer 30 can also be detached from the first frame member 34 when the pivot retainer 54 has been removed. This shows one embodiment of the user disassembling the knife 1 according to at least one preferred disassembly process. However, the user, can, if they wish leave the pin 26 extending through the first pivot retainer 30, and would not have to remove the first pin 26 from it. In fact, according to one or more embodiments, a user may not be able to remove the first pin 26 from the first pivot retainer 30 without using tools, but rather can use just the their fingers to remove the combined pivot retainer 30 and the pin 26 from the hole as it is firmly attached to the first frame member 34.

FIG. 10A shows removing a back frame member 18, a blade 10, a first frame member 34, and a second frame member 46 according to a preferred disassembly process according to one embodiment of the present disclosure.

As shown in FIG. 10A, after the second pivot retainer 54 is removed, the back frame member 18, the blade 10, the first frame member 34, and the second frame member 46 can be taken apart using the user's fingers. That is, there is no longer a component that hangs onto the back frame member 18, the blade 10, the first frame member 34, and the second frame member 46 and the user may exert a slight amount of force to separate the parts.

FIG. 10A shows a pin 70 separated from the back frame member 18. However, this merely shows the components piece-by-piece and, generally, a user will not be able to release the pin 70 from the back frame member 18 just by using their fingers. FIG. 10A does not illustrate a first pin 26. This is to simplify some of the views and as described above, under the preferred disassembly process, the first pin 26 and the first pivot retainer are not detached from the first frame member 34.

FIG. 10A is generally the last step of the preferred disassembly process.

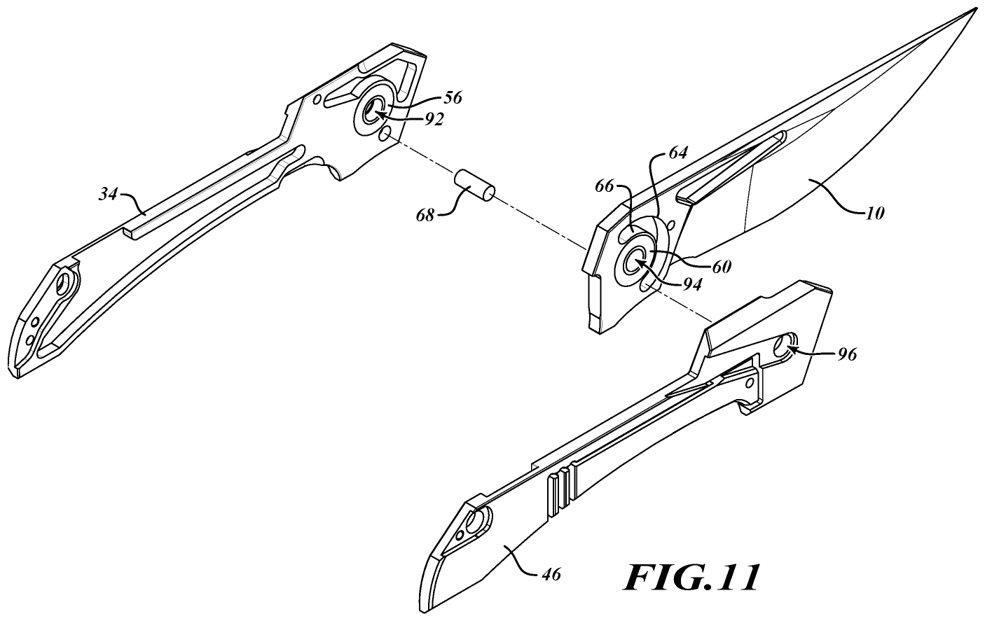

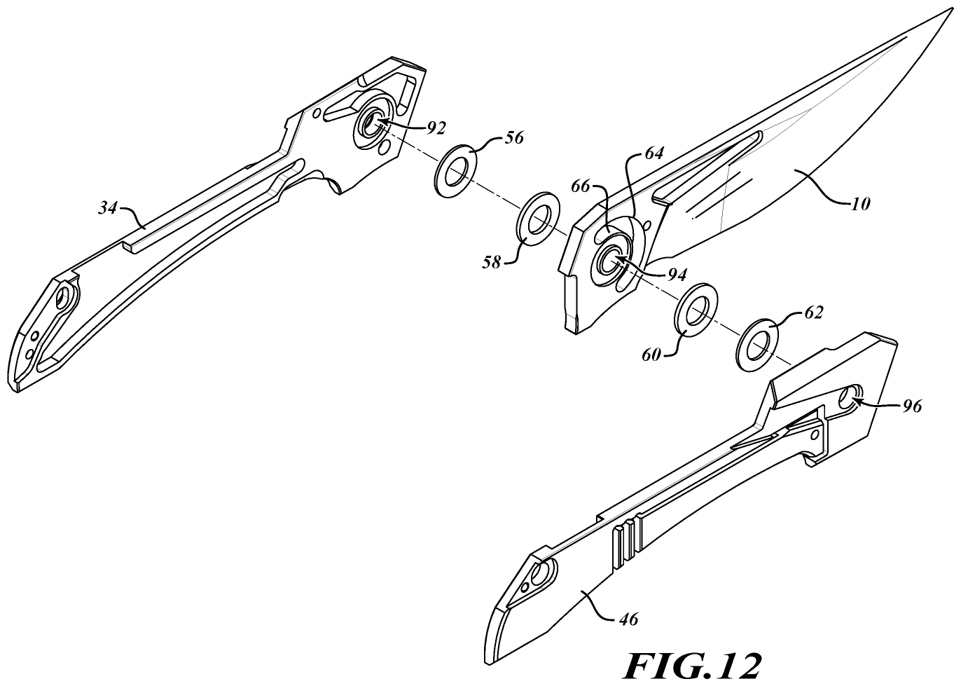

FIGS. 11 and 12 show that the knife may be further dismantled as was shown in the exploded view of FIG. 3. However, a user would not be able to use the user's fingers to remove pin 68 and further remove the bearings 58, 60 and the washers 56, 62 solely using the user's fingers.

The various components of the knife 1 including frame members used may be manufactured using titanium. However, this is only one example and other materials available in the art may be used to manufacture the components of the knife according to the present disclosure.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A knife comprising:
a blade;
a handle coupled to the blade, the handle including a first frame member having a first hole and a second frame member having a second hole facing the first frame member, the first hole and the second hole of the first and second frame members being aligned with each other;
a rotatable latch having a third hole there through, the latch configured to be rotatable about a first axis and being positioned between the first and second frame members with its third hole aligned with the first hole and the second hole;
a back frame member positioned between the first frame member and the second frame member, the back frame member configured to be rotatable about a second axis at a second end of the handle opposite of a first end, the back frame member having a fourth hole that is aligned with the holes of the first and second frame member and the third hole of the latch along the first axis; and
a first connection pin having a first axis, the connection pin extending through the first hole, the second hole, the third hole, and the fourth hole.

2. The knife according to claim 1, wherein:
the latch is rotatable about the first connection pin on the first axis, and
the first connection pin is configured to be removable from the first hole, the second hole, the third hole, and the fourth hole and when removed, releases the latch from its position between the first frame member and the second frame member.

3. The knife according to claim 2, wherein the first connection pin includes a first section that extends through the first hole of the first frame member, and the first section of the first connection pin is configured to rotate within the first hole of the first frame member between a closed position and an open position.

4. The knife according to claim 3, wherein the first connection pin includes a second section that extends through the third hole of the latch, and
wherein the second section of the first connection pin has a size and dimension that snuggly fits into the third hole of the latch to be concurrently rotated with a rotation of the latch between the closed position and the open position.

5. The knife according to claim 4, wherein the first connection pin includes a third section that extends through the fourth hole of the back frame member, and
wherein the third section of the first connection pin holds the back frame member from rotating about the second axis.

6. The knife according to claim 2, comprising a second connection pin extending through a fifth hole of the first frame member, a sixth hole of the blade, and a seventh hole of the second frame member.

7. The knife according to claim 6, further comprising a pivot retainer on the second frame member of the handle, the pivot retainer having an end configured to fasten a portion of the second connection pin protruding from the seventh hole of the second frame member.

8. The knife according to claim 7, wherein a bottom surface of the back frame member contacting a top surface of the pivot retainer adjacent to the second frame member of the handle pushes down the pivot retainer from moving from its position.

9. The knife according to claim 8, wherein the pivot retainer is configured to be manually-releasable along a third axis different from the first and second axes, when the back frame member rotates along the second axis to release itself from a closed position of the back frame member and the bottom surface of the back frame member becomes spaced apart from top surface of the pivot retainer,
wherein the back frame member is in a closed position until the first connection pin is released from the fourth hole of the back frame member and is capable of rotating about the second axis.

10. The knife according to claim 2, comprising a holding pin extending between the first frame member and the second frame member, the holding pin fixated to at least one of the first frame member or the second frame member,
wherein the latch includes a recess that contacts and rests on the holding pin.

11. The knife according to claim 2, comprising a first detent on an inner side of the first frame member facing the latch, the first detent disposed adjacent to the first hole of the first frame member,
wherein the first detent is configured to resist movement of the latch from a closed position.

12. The knife according to claim 2, comprising a pocket clip including an eighth hole,
wherein the first connection pin extends through the eighth hole of the pocket clip, the fourth hole of the back frame member, the first hole of the first frame member, the second hole of the second frame member, and the third hole of the latch.

13. The knife according to claim 12, comprising a second detent on an outer side of the second frame member facing the pocket clip, the second detent disposed adjacent to the second hole of the second frame member.

14. The knife according to claim 13, wherein the second detent is configured to resist movement of the pocket clip.

15. A method of disassembling a knife comprising:
releasing a latch positioned at a first end of a handle of the knife, the latch having a first hole extending there through;
rotating the latch about a first connection pin along a first axis, the connection pin extending through the hole of the latch, a second hole in a first frame member, a third hole in a second frame member of the handle, and a fourth hole in a back frame member, the back frame member being disposed between the first and second frame members of the handle;
removing the pin from the first hole of the latch, the second hole in the first frame member and the third hole in the second frame member of the handle, and the fourth hole in the back frame member;
disengaging the back frame member from the first end of the handle of the knife by rotating the back frame member along a second axis; and
removing a pivot retainer that is positioned adjacent to a second end of the knife.

16. The method of claim 15, comprising:
removing a second connection pin from the first and second frame members and a blade of the knife; and
disengaging the blade of the knife from the first frame member and the second frame member.

17. The method of claim 15, wherein releasing a rotatable latch positioned at an end of a handle of the knife includes:
disengaging the latch from a holding pin connected between the first frame member and the second frame member of the handle.

18. The method of claim 17, wherein releasing a rotatable latch positioned at an end of a handle of the knife includes:
disengaging the latch from a detent disposed in an inner side surface of the first frame member of the handle.

19. A knife comprising:
a handle including a first frame member and a second frame member facing the first frame member,
a blade being removably secured to the handle and rotatable between an open and a closed position;
a latch configured to be moved between engaged with, and disengaged from, a holding pin connected between the first frame member and the second frame member, and, while the latch is engaged with the holding pin, the blade, the first frame member, and the second frame member cannot be disassembled; and
a first connection pin sized to engage with, and disengage from, first and second holes of the first frame member and the second frame member, respectively, and a third hole of the latch, a head of the first connection pin engages with the first hole of the first frame member to rotate within the first hole of the first frame member between a locked and an unlocked position.

20. The knife of claim 19, comprising:
a back frame member disposed between the first frame member and the second frame member, the back frame member rotatable along an axis different from axes about which the blade and the latch rotate;
a second connection pin extending through the first frame member, the second frame member, and the blade; and
a pivot retainer on the second frame member, the pivot retainer removably secured to the second connection pin, the pivot retainer, configured to be slidably removed from the second frame member when the back frame member rotates to disengage from the pivot retainer.
